(19) United States
(12) Patent Application Publication
(10) Pub. No.: US 2026/0047710 A1
(43) Pub. Date: Feb. 19, 2026

(54) THERMOCHROMIC FLOOR MAT

(71) Applicant: JIDE YU, Yiwu (CN)

(72) Inventor: JIDE YU, Yiwu (CN)

(21) Appl. No.: 18/806,173

(22) Filed: Aug. 15, 2024

(51) Int. Cl. A47G 27/02; G02F 1/01

(52) U.S. Cl. CPC A47G 27/02; G02F 1/0147

(57) ABSTRACT

A thermochromic floor mat is provided, which includes a floor mat body. The floor mat body is composed of PTE film, printing layer, OPP film, temperature sensing ink layer, PVC film, and injection molding layer from top to bottom. The temperature sensing ink layer forms a plurality of thermochromic patterns at a bottom of the OPP film. The OPP film is a transparent film, suction cups are connected to the injection molding layer. And a production process for thermochromic floor mat is provided, which includes preparing a thermochromic printing film, an injection molding raw material, and injection molding. The temperature sensing ink layer is provided in the floor mat, the temperature sensing ink layer is provided with temperature sensitive color powder. The temperature sensing ink layer is provided between the OPP film and the PVC film to prevent the temperature sensing ink layer from falling off after long-term use.

### TECHNICAL FIELD

The present disclosure relates to the field of floor mat technologies, and in particular, to a new thermochromic floor mat.

### BACKGROUND

The applicant has applied a Chinese invention (patent number: 201520416986.0) on Jun. 13, 2015, and it disclosed a thermochromic floor mat, which includes a mat body. The surface of the mat body is sequentially provided with a plurality of inward concave storage slots from left to right. Each storage slot is glued with different text pattern decorative bodies added with thermochromic powder. These text pattern decorative bodies have gaps between them and the circumferential wall of the storage slot where they are stored; according to the order of the storage slots from left to right, the temperature of the thermochromic powder added to the text pattern decoration gradually increases from low to high. And text pattern decorations were arranged with different temperature sensing and color changing temperatures on the mat body. Of course, when they are arranged in the bathroom and hot water is poured, the temperature range of the water can be easily determined by the text pattern decorations with different temperature sensing and color changing temperatures on the mat body, thereby preventing burns and cooling.

The temperature sensitive color powder in the above technical solution is glued to the storage slots. After prolonged use with water, the glue is prone to aging, and the temperature sensitive color powder is easily detached from the storage slot. The floor mat cannot undergo thermochromic and has a short service life.

### SUMMARY

The present disclosure provides a thermochromic floor mat designed to address the shortcomings of the existing technology.

The technical solution adopted by the present disclosure to solve the above problems is as follows.

The present disclosure provides a thermochromic floor mat, including:
a floor mat body, which consists of a PTE film, a printing layer, an OPP film, a temperature sensing ink layer, a PVC film, and an injection molding layer from top to bottom; the temperature sensing ink layer forms a plurality of thermochromic patterns at a bottom of the OPP film, and the temperature sensing ink layer is a transparent film;
a plurality of suction cups that are connected to the injection molding layer.

In some embodiments of the present disclosure, the injection molding layer and the suction cups are integrally formed on a side of the PVC film away from the temperature sensing ink layer by an injection molding machine.

In some embodiments of the present disclosure, the suction cups are uniformly distributed on a side of the injection molding layer.

In some embodiments of the present disclosure, the temperature sensing ink layer is sprayed onto the bottom of the OPP film by an inkjet printer.

In some embodiments of the present disclosure, color changing temperatures of the temperature sensing ink layer are 28° C., 37° C., and 45° C., respectively.

The present disclosure further provides a novel production process for thermochromic floor mats, which includes the following steps:
step 1, preparing a thermochromic printing film: injecting a thermochromic ink into an oil tank of a printing machine, depositing onto the OPP film according to a predetermined pattern with printing technique; after printing, feeding the OPP film into an oven for drying, taking it out, then proofreading, cutting a printing film into a predetermined size with a dedicated cutting machine to obtain the thermochromic printing film;
step 2, preparing an injection molding raw material: the injection molding raw material is composed of 50-60 parts by weight of polyvinyl chloride resin powder, 20-30 parts by weight of dioctyl terephthalate, 10-12 parts by weight of soybean oil, 5-7 parts by weight of dibutyl sebacate, 1-2 parts by weight of naphthenic soap, and 1-2 parts by weight of modified filler;
where the modified filler is composed of 3-4 parts by weight of methane amide, 50-60 parts by weight of attapulgite, 0.1-0.2 parts by weight of silane coupling agent kh560, 5-7 parts by weight of hydroxy propyl methyl cellulose;
adding the hydroxy propyl methyl cellulose to deionized water at 20-26 times a weight of the hydroxy propyl methyl cellulose, stirring evenly, adding the formamide, raising a temperature to 50-60° C., adding the attapulgite, keeping warm and stirring for 1-2 hours, adding the silane coupling agent kh560, stirring at 600-700 rpm for 4-10 minutes, filtering, and vacuum drying a precipitate at 100-105° C. for 20-30 minutes to obtain the modified filler;
step 3, injection molding: mixing the injection molding materials in step 2, stirring evenly, and feeding them into a hopper; heating temperature of a screw barrel for an injection molding machine to 165-180° C., and sticking a cut printed film onto a mold; injecting the injection molding material into the mold with the printed film, pressurization to form molding, curing, demolding, and forming an injection molding layer at a bottom of the PVC film; trimming excess burrs so as to obtain a finished product.

The beneficial effects of the present disclosure are as follows: the technical solution provides a thermochromic floor mat, which includes the floor mat body. The floor mat body is composed of PTE film, printing layer, OPP film, temperature sensing ink layer, PVC film, and injection molding layer from top to bottom. The temperature sensing ink layer forms a plurality of thermochromic patterns at the bottom of the OPP film. The OPP film is a transparent film, and the suction cups are connected to the injection molding layer. In addition, the technical solution further provides a production process for the thermochromic floor mat, which includes preparing thermochromic printing film, injection molding raw materials, and injection molding. The temperature sensing ink layer is provided in the floor mat, which contains temperature sensitive color powder. Color change is achieved through temperature changes, the temperature sensing ink layer is provided between the OPP film and PVC film so as to prevent the ink layer from falling off after prolonged use and have a long service life.

### BRIEF DESCRIPTION OF DRAWINGS

In order to provide a clearer explanation of the embodiments of the present disclosure or the technical solutions in the prior art, a brief introduction will be given to the accompanying drawings required for the description of the embodiments or the prior art. It is obvious that the accompanying drawings described below are only some embodiments of the present disclosure. For those skilled in the art, other drawings can be obtained based on the structures shown in these drawings without creative work.

FIG. 1 is a front view of a thermochromic floor mat according to the present disclosure.

FIG. 2 is a rear view of the thermochromic floor mat according to the present disclosure.

FIG. 3 is a cross-sectional view of the thermochromic floor mat according to the present disclosure.

Numeral reference: 1—floor mat body, 101—PTE film, 102—printing layer, 103—OPP film, 104—temperature sensing ink layer, 105—PVC film, 106—injection molding layer, 2—pattern, 3—suction cup.

### DESCRIPTION OF EMBODIMENTS

In order to enable those skilled in the art to better understand the technical solution of the present application, the following will provide a clear and complete description of the technical solution in the embodiments of the present application in combination with the accompanying drawings. Obviously, the described embodiments are only a part of the embodiments of the present application, not all of them. Based on the embodiments of the present disclosure, all other embodiments obtained by those skilled in the art without creative work are within the protection scope of the present application.

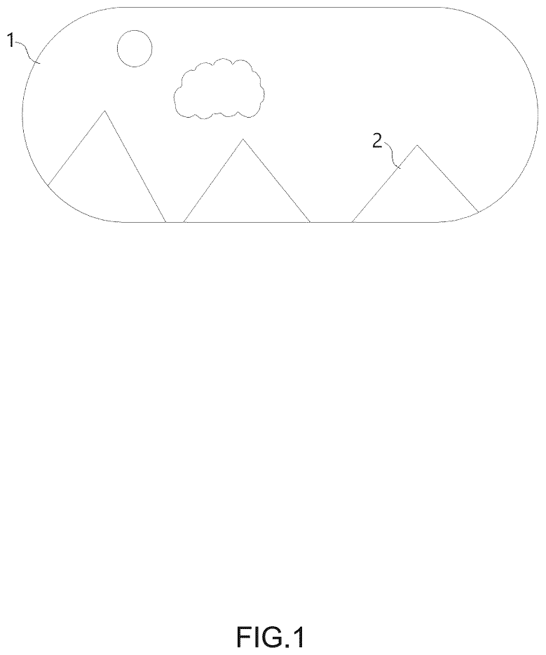

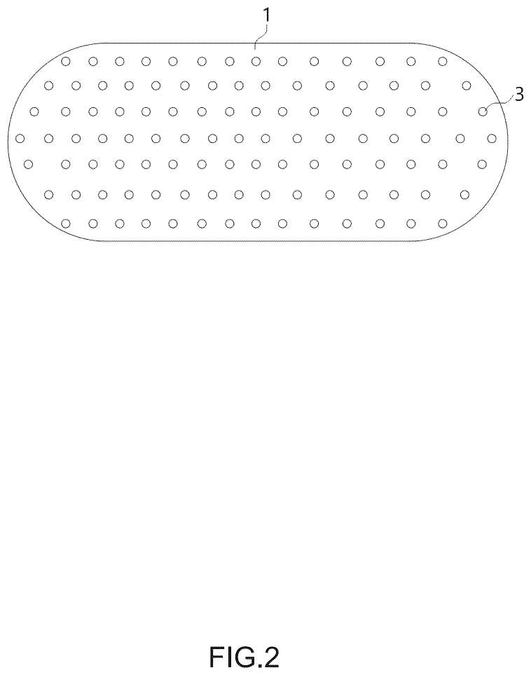

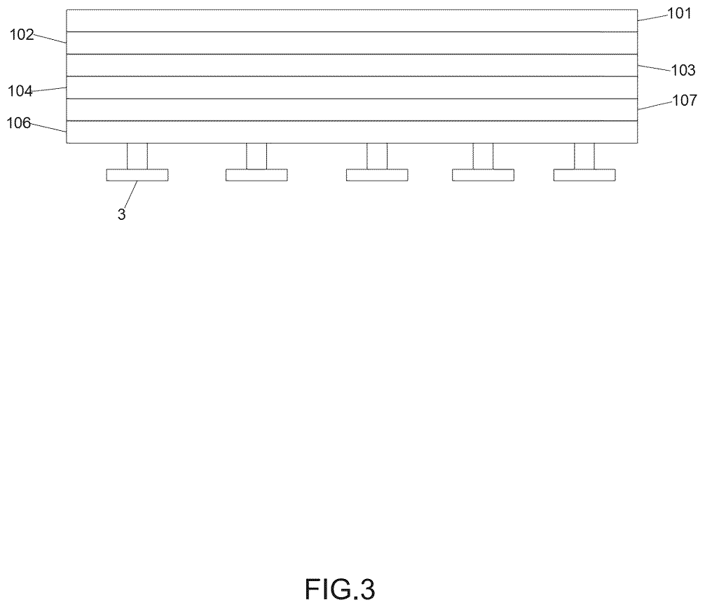

Referring to FIGS. 1-3 of the specification, some embodiments provide a floor mat body 1, which is composed of a PTE (polyethylene glycol terephthalate) film 101, a printing layer 102, an OPP (polypropylene) film 103, a temperature sensing ink layer 104, a PVC (polyvinylchloride) film 105, and an injection molding layer 106 from top to bottom. The temperature sensing ink layer 104 forms a plurality of thermochromic patterns 2 at a bottom of the OPP film 103. The OPP film 103 is a transparent film, and the suction cups 3 are connected to the injection molding layer 106. The temperature sensing ink layer 104 is provided in the floor mat, and the temperature sensing ink layer 104 contains temperature sensitive color powder that can be changed by temperature changes. The temperature sensing ink layer 104 is provided between the OPP film 103 and the PVC film 105 so as to prevent the temperature sensing ink layer from peeling off after prolonged use, and therefore ensuring a long service life.

In an implementation, the injection molding layer 106 and the suction cup 3 are integrally formed on a side of the PVC film 105 away from the temperature sensing ink layer 104 through an injection molding machine. During production and processing, the PTE film 101, printing layer 102, OPP film 103, temperature sensing ink layer 104, and PVC film 105 are first connected, and then the bottom of the PVC film 105 is injected through an injection molding machine to form the injection molding layer 106 and suction cups 3. The production and processing are simple, and the suction cups are connected to the injection molding layer with high strength, which is not easy to fall off.

In an implementation, the suction cups 3 are evenly distributed on one side of the injection molding layer 106, allowing the floor mat to be connected to the ground at all positions with high connection strength.

In an implementation, the temperature sensing ink layer 104 is sprayed onto a bottom of the OPP film 103 through an inkjet printer.

In an implementation, the color changing temperatures of the temperature sensing ink layer 104 are 28° C., 37° C., and 45° C., respectively.

Basic temperatures for temperature sensing and color change are 22° C., 28° C., 33° C., 35° C., 37° C., 40° C., 45° C., 50° C., 65° C., 70° C., 78° C. Taking 37° C. which will be red as an example, the color change is colorless above 37° C. and red below 37° C. In an implementation, the color changing temperatures are 28° C., 37° C., and 45° C., and there are mainly based on the fact that floor mat is generally used for bathing in a bathroom and is more suitable for people's optimal bathing temperature around 40° C.

The present disclosure further provides a production process for thermochromic floor mat, which includes the following specific steps:
step 1, preparing a thermochromic printing film: injecting a thermochromic ink into an oil tank of a larger printing machine, depositing onto the OPP film according to a predetermined pattern with printing technique; after printing, feeding the OPP film into an oven for drying, taking it out, then proofreading, cutting a printing film into a predetermined size with a dedicated cutting machine to obtain the thermochromic printing film;
step 2, preparing an injection molding raw material: the injection molding raw material is composed of 50-60 parts by weight of polyvinyl chloride resin powder, 20-30 parts by weight of dioctyl terephthalate, 10-12 parts by weight of soybean oil, 5-7 parts by weight of dibutyl sebacate, 1-2 parts by weight of naphthenic soap, and 1-2 parts by weight of modified filler;
where the modified filler is composed of 3-4 parts by weight of methane amide, 50-60 parts by weight of attapulgite, 0.1-0.2 parts by weight of silane coupling agent kh560, 5-7 parts by weight of hydroxy propyl methyl cellulose;
adding the hydroxy propyl methyl cellulose to deionized water at 20-26 times a weight of the hydroxy propyl methyl cellulose, stirring evenly, adding the formamide, raising a temperature to 50-60° C., adding the attapulgite, keeping warm and stirring for 1-2 hours, adding the silane coupling agent kh560, stirring at 600-700 rpm for 4-10 minutes, filtering, and vacuum drying a precipitate at 100-105° C. for 20-30 minutes to obtain the modified filler;
step 3, injection molding: mixing the injection molding materials in step 2, stirring evenly, and feeding them into a hopper; heating temperature of a screw barrel for an injection molding machine to 165-180° C., and sticking a cut printed film onto a mold; injecting the injection molding material into the mold with the printed film, pressurization to form molding, curing, demolding, and forming an injection molding layer at a bottom of the PVC film; trimming excess burrs so as to obtain a finished product.

From the above description, it can be seen that the embodiments of the present disclosure have achieved the following technical effects.

A new type of thermochromic floor mat is provided, which includes a floor mat body. The floor mat body is composed of PTE film, printing layer, OPP film, temperature sensing ink layer, PVC film, and injection molding layer from top to bottom. The temperature sensing ink layer forms a plurality of thermochromic patterns at the bottom of the OPP film. The OPP film is a transparent film, and the suction cups are connected to the injection molding layer. In addition, this technical solution further provides a production process for the thermochromic floor mat, which includes preparing thermochromic printing film, preparing injection molding raw materials, and injection molding. The temperature sensing ink layer is provided in the floor mat, and the temperature sensing ink layer is provided with temperature sensitive color powder, which can change color through temperature changes. The temperature sensing ink layer is provided between the OPP film and the PVC film so as to prevent the temperature sensing ink layer from falling off after long-term use and have a long service life.

It should be noted that terms used here are only intended to describe specific embodiments and are not intended to limit the exemplary embodiments according to the present application. As used herein, unless otherwise explicitly stated in the specification, a singular form is also intended to include a plural form. Additionally, it should be understood that when terms “including” and/or “comprising” are used in this specification, they indicate the presence of a feature, a step, an operation, a device, a component, and/or a combination thereof.

Unless otherwise specified, a relative arrangement, numerical expression, and value of the component and step described in these embodiments do not limit the scope of the present application. At the same time, it should be understood that for ease of description, the dimensions of the various parts shown in the attached drawings are not drawn according to an actual proportional relationship. For technologies, methods, and equipment known to ordinary technical personnel in related fields, detailed discussions may not be made, but in an appropriate circumstance, such technologies, methods, and equipment should be considered as a part of the specification. In all examples shown and discussed here, any specific value should be interpreted as merely illustrative and not restrictive. Therefore, other examples of exemplary embodiments may have different values. It should be noted that similar labels and letters represent similar items in the following drawings. Therefore, once an item is defined in one drawing, it does not need to be further discussed in subsequent drawings.

In the description of the present application, it should be understood that directional words such as “front”, “back”, “up”, “down”, “left”, “right”, “horizontal”, “vertical”, “perpendicularity”, “horizontal”, “top” and “bottom” usually indicate directional or positional relationships based on the directional or positional relationships shown in the accompanying drawings. This is only for a convenience of describing the present application and simplifying the description. Unless otherwise stated, these directional words do not indicate or imply that the device or component referred to must have a specific orientation or be constructed and operated in a specific orientation, and therefore cannot be understood as limiting the protection scope of the present application. In addition, the directional words “inside”and “outside”refer to the inner and outer contours relative to each component itself.

It should be understood that when a component is referred to as “on” or “connected” to another component, it can be directly connected to or directly connected to the other component, or indirectly connected by an inserted component between the two. On the contrary, when a component is referred to as “directly” on top of or “directly connected” to another component, there is no inserted component between the two.

In addition, it should be noted that in the description of the present disclosure, the use of words such as “first” and “second” to define components is only for the purpose of distinguishing the corresponding components. If not otherwise stated, the above words do not have a special meaning and therefore cannot be understood as limiting the protection scope of the present application. In the description of the present disclosure, unless otherwise specified, the meaning of “a plurality of”refers to two or more.

The above are preferred embodiments of the present disclosure. It should be pointed out that for those skilled in the art, a plurality of improvements and embellishments can be made without departing from the principles of the present disclosure. These improvements and embellishments are also considered to be within the protection scope of the present disclosure.

What is claimed is:

1. A thermochromic floor mat, comprising:
a floor mat body, which consists of a PTE film, a printing layer, an OPP film, a temperature sensing ink layer, a PVC film, and an injection molding layer from top to bottom; the temperature sensing ink layer forms a plurality of thermochromic patterns at a bottom of the OPP film, and the temperature sensing ink layer is a transparent film;
a plurality of suction cups that are connected to the injection molding layer.

2. The thermochromic floor mat according to claim 1, wherein the injection molding layer and the suction cups are integrally formed on a side of the PVC film away from the temperature sensing ink layer by an injection molding machine.

3. The thermochromic floor mat according to claim 2, wherein the suction cups are uniformly distributed on a side of the injection molding layer.

4. The thermochromic floor mat according to claim 3, wherein the temperature sensing ink layer is sprayed onto the bottom of the OPP film by an inkjet printer.

5. The thermochromic floor mat according to claim 1, wherein color changing temperatures of the temperature sensing ink layer are 28° C., 37° C., and 45° C., respectively.

6. A production process for the thermochromic floor mat according to claim 1, wherein the production process comprises the following specific steps:
step 1, preparing a thermochromic printing film: injecting a thermochromic ink into an oil tank of a printing machine, depositing onto the OPP film according to a predetermined pattern with printing technique; after printing, feeding the OPP film into an oven for drying, taking it out, then proofreading, cutting a printing film into a predetermined size with a dedicated cutting machine to obtain the thermochromic printing film;
step 2, preparing an injection molding raw material: the injection molding raw material is composed of 50-60 parts by weight of polyvinyl chloride resin powder, 20-30 parts by weight of dioctyl terephthalate, 10-12 parts by weight of soybean oil, 5-7 parts by weight of dibutyl sebacate, 1-2 parts by weight of naphthenic soap, and 1-2 parts by weight of modified filler;
wherein the modified filler is composed of 3-4 parts by weight of methane amide, 50-60 parts by weight of attapulgite, 0.1-0.2 parts by weight of silane coupling agent kh560, 5-7 parts by weight of hydroxy propyl methyl cellulose;
adding the hydroxy propyl methyl cellulose to deionized water at 20-26 times a weight of the hydroxy propyl methyl cellulose, stirring evenly, adding the formamide, raising a temperature to 50-60° C., adding the attapulgite, keeping warm and stirring for 1-2 hours, adding the silane coupling agent kh560, stirring at 600-700 rpm for 4-10 minutes, filtering, and vacuum drying a precipitate at 100-105° C. for 20-30 minutes to obtain the modified filler;
step 3, injection molding: mixing the injection molding materials in step 2, stirring evenly, and feeding them into a hopper; heating temperature of a screw barrel for an injection molding machine to 165-180° C., and sticking a cut printed film onto a mold; injecting the injection molding material into the mold with the printed film, pressurization to form molding, curing, demolding, and forming an injection molding layer at a bottom of the PVC film; trimming excess burrs so as to obtain a finished product.
